(19) United States
(12) Patent Application Publication
(10) Pub. No.: US 2006/0034992 A1
(43) Pub. Date: Feb. 16, 2006

(54) Flavor and fragrance compounds

(76) Inventors: Jean Paul Nelissen, Watt (CH); Klaus Gassenmeier, Dubendorf (CH); Stefan Michael Eurrer, Cincinnati, OH (US)

Correspondence Address: CURATOLO SIDOTI CO., LPA, 24500 CENTER RIDGE ROAD, SUITE 280, CLEVELAND, OH, 44145, US

(21) Appl. No.: 10/534,435

(22) PCT Filed: Nov. 26, 2003
(86) PCT No.: PCT/CH03/00784

§ 371 Date: May 10, 2005

(30) Foreign Application Priority Data
Nov. 28, 2002 (GB) 0227681.4

(51) Int. Cl. A23L 1/22

(52) U.S. Cl. 426/534

(57) ABSTRACT

Acetaldehyde precursors useful in flavors and fragrances, especially in consumable products, are according to the formula I 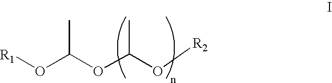
wherein R₁ and R₂ are selected such that both are —CH₂CH₃, or both are linear, branched or cyclic alkyl, aryl, alcohol or sugar residues, and n=1-10, with the proviso that, when R₁ and R₂ are selected such that both are —CH₂CH₃, n=1, 2, 3 or 4. The precursors overcome many of the disadvantages of present sources of acetaldehyde in consumable products.

The invention relates to novel compounds for imparting acetaldehyde to flavor or fragrance compositions or food products or fragrance products (acetaldehyde precursors). These acetaldehyde precursors release acetaldehyde under certain conditions in said products.

It is known that acetaldehyde is a valuable ingredient in a wide variety of fresh and prepared food products, where it adds a fresh character, e.g. in vegetables such as carrot, celery, cucumber, mushroom, onion, garlic, peas, potato, and tomato, in spices such as ginger, cumin, fennel, mustard and rosemary, and in fruits, such as apple, arctic bramble, banana, bilberry, cherry, citrus fruits, cranberry, currants, grape, morello, olive, orange, passionfruit, peach, plum, red berry, strawberry and raspberry. It can also be used in meat products, dairy products, bakery and confectionery products (B. Byrne and G. Sherman, “Stability of Dry Acetaldehyde Systems”, Food Technology, 38(7), 57-61, 1984. The fresh character of the acetaldehyde is highly desirable for consumers, especially in orange juice and other citrus juices, and therefore in the corresponding flavors and flavor compositions.

However, adding acetaldehyde to flavor or fragrance compositions or to food or fragrance products has the following drawbacks. Concentrated liquid preparations containing acetaldehyde are difficult to handle because of their high volatility and inflammability. Furthermore, acetaldehyde is chemically unstable and may polymerize, oxidize or combine with other materials or itself in presence of an acid or a base.

Flavor or fragrance preparations containing acetaldehyde have a low flash point and are not desirable for safety reasons. Since it is difficult to apply directly, spray-dried acetaldehyde is a widely used product. However, because of its high volatility, significant losses may occur during spray drying. Apart from being difficult to entrap, acetaldehyde is not stable in many systems and a significant amount is rapidly lost when exposed to the atmosphere under ambient conditions, or even in packaged form, if small amounts of water are present.

Various attempts have been made to overcome the problems encountered with acetaldehyde use. These have included the protection of the molecule in a matrix containing starches and sugars, which can be done by spray drying (B. Byrne and G. Sherman, “Stability of Dry Acetaldehyde Systems”, Food Technology, 38(7), 57-61, 1984.). However, the spray drying system has been shown to be not as effective as a system employing chemicals that degrade to release acetaldehyde (R. S. DeSimone and B. Byrne, “Aldehyde Generator for Flavors”, Perfurmer & Flavorist, Vol. 11, p. 15-26, 1987).

U.S. Pat. No. 4,280,011 and U.S. Pat. No. 5,079,023 disclose several chemical precursors, which are acetals that hydrolyze to give acetaldehyde. One of these chemical precursors is 1, 2-di[(1′-ethoxy)ethoxy]propane (ALDEMAX, CAS 67715-79-1). A limitation to the usefulness of acetals that release their corresponding aldehydes is that they provide their own characteristic aroma (flavor or odor), which often might not be desired.

U.S. Pat. No. 4,781,762 discloses another type of chemical precursor of acetaldehyde that incorporates the functionality of a carboxylate. These precursors release acetaldehyde and have relatively short half-lives in the order of minutes in acid media.

However, the known acetaldehyde precursors are prone to decompose during spray-drying or the compounding of flavors or fragrances, or when exposed to water or even atmospheric humidity. Compounding with other ingredients such as alcohols and acids might lead to reactions of the acetaldehyde precursors to yield undesired by-products, e.g. various hemi-acetals and acetals. Together with propylene glycol, which is used frequently in the flavor industry, stable acetals are formed that are perceived organoleptically as off-flavors. Even relatively stable precursors e.g. acetals such as 1,2-di[(1′-ethoxy)ethoxy]propane may hydrolyse prematurely under unfavorable conditions occurring during flavor or fragrance compounding, formulation into a food or fragrance product, or during transport and storage.

Another limiting factor to the effectiveness of chemical precursors relates to their release time. Known precursors do not release acetaldehyde fast enough in some applications, depending on factors such as the pH of the release media A further factor relates to regulatory requirements: These compounds are classified as “artificial” since their structures do not occur in nature. Flavors made with known acetaldehyde precursors cannot be designated as natural flavors.

There remains a need for chemical precursors which are chemically inert and stable under formulation, transport and storage conditions, but not so that they do not release acetaldehyde rapidly when required. Furthermore, they should not result in undesired side products and should not interfere with the aroma or taste of the desired flavor or fragrance.

Surprisingly, the problems associated with the prior art are overcome with the provision of new acetaldehyde precursor compounds.

Therefore, the invention provides an acetaldehyde precursor according to formula I 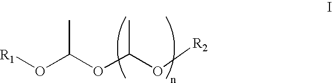
wherein R₁ and R₂ are selected such that both are —CH₂CH₃, or both are linear, branched or cyclic alkyl, aryl, alcohol or sugar residues, and n=1-10, with the proviso that, when R₁ and R₂ are selected such that both are —CH₂CH₃, n=1, 2, 3 or 4.

The acetaldehyde precursor of formula I with n=1 and R₁ and R₂ both —CH₂CH₃ is stable under neutral pH conditions but rapidly releases acetaldehyde under acidic conditions. The half-life times of an acetaldehyde precursor of formula I with n=1 at pH 2.8, 3.18, 3.81 and 4.14 are calculated from the measurements described in the following description and indicated in the table below.

| | pH value | | | |
|---|---|---|---|---|
| | 2.8 | 3.18 | 3.81 | 4.14 |
| rate constant | 0.005966 | 0.003446 | 0.00069 | 0.000382 |
| k in 1/second* | | | | |
| half life time | 116 | 201 | 1004 | 1813 |
| λ in seconds | | | | |

*Precursor + H₂O −> Ethanol + Acetaldehyde

The acetaldehyde precursor of formula I with n=1 releases acetaldehyde significantly faster (half-life pH3.0=306 seconds, pH 3.5=966 sec.) than 1,2-di[(1′-ethoxy)ethoyx]propane (half-life at pH 3.0=625 sec, pH 3.5=3906 seconds) and faster than the monomer, acetaldehyde diethyl acetal, (half-life at pH 3.0=579 sec, pH 3.5=2493 sec.). Since the acetaldehyde precursor according to formula I with n=1 (dimer) releases acetaldehyde faster than the monomer with n=0, the trimer with n=2 is expected to release acetaldehyde at least as rapidly as the dimer.

Compounds of formula I where R₁ and R₂ are selected from linear, branched or cyclic alkyl, aryl, alcohols or sugar residues, and n is larger than 4, for example 5, 6, 7, 8, 9, 10, may also act as acetaldehyde precursors. However, such compounds with increasing n value decrease in aqueous solubility, and therefore R1 and R2 should be selected from hydrophilic residues such as alcohols or sugars, so that the compound is still soluble.

The preferred precursors according to this invention are those wherein R₁ and R₂ are selected such that both are —CH₂CH₃, that is, when the precursor has the formula II 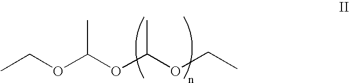
and that n is selected from 1, 2, 3, or 4, more preferably from 1, 2 or 3.

It is possible and permissible that more than one such precursor compound may be used in any given application and the use of the singular in this description also covers this possibility.

The release rate of acetaldehyde from the precursor according to formula II with n=1 is measured and compared to 1,2-di[(1′-ethoxy)ethoxy]propane and acetaldehyde diethyl. The measurements are conducted as described in S. M. Oon and D. G. Kubler, “Hydrolysis of Aldal Acetals”, J. Org. Chem., 1982, 47, 1166-1171. A phosphate buffer solution (2 mL) is placed into a quartz cuvette and 5 mg of the respective acetaldehyde precursor is added. The mixture is mixed well and sealed using Parafilm™. The release of acetaldehyde is monitored in a UV-Photometer measuring the increase of the extinction at 280 nm over time. Depending on reaction speed, all 3 to 10 seconds measurements are conducted. Obtained formation curves of acetaldehyde at pH 2.8, pH 3.18, pH 3.81 and pH 4.14 are very well represented by the formula C₍ₜ₎=C₀+Cₓ×(1−e^{-kt}), wherein C₍ₜ₎ the absorption corresponding to the concentration of acetaldehyde at time t, C₀ absorption corresponding to the concentration of acetaldehyde at time t=0, Cₓ the total amount of acetaldehyde present in the precursor, k the rate constant and t the reaction time. The rate constants are calculated by a numeric approximation program (TABLE CURVE 2D, ©AISN Software Inc.). The half life time λ is calculated from the rate constant using the equation λ=−ln(0.5)/k.

Application of acetaldehyde precursors of the present invention in food and fragrance products or formulations dramatically reduces the risk of ignition and explosion: whereas the flash point of an orange flavor A (example 1) with 10% acetaldehyde is below −10° C., the flash point of an orange flavor B (example 1) with an acetaldehyde precursor corresponding to 10% acetaldehyde according to formula I with n=1 is +48° C.

An acetaldehyde precursor according to formula II with n=1 occurs in nature and therefore does not have to be designated as “artificial” in food products for regulatory reasons. A sample of REDD NATURAL ACETALDEHYDE FRAC (Givaudan Lakeland, Fla.) is analysed by GC-MS using splitless injection mode on a DB-1 and DB-WAX column. The mass spectrum and retention time matches the reference substance 1-ethoxy-1-(1-ethoxy-ethoxy)-ethane (compound according to formula (I) with n=1, CAS 80243-06-7). The retention indices based on methyl ester references are 631 on a DB-1 (J&W, Palo Alto, USA, 30 m×0.32 mm i.D.×0.25 um film, Part 123-1032) column and 578 on a DB-WAX column (J&W, Palo Alto, USA, 30 m×0.32 mm i.D.×0.25 um film thickness, Part 123-7032).

Apart from a rapid release of acetaldehyde under acidic conditions, a further advantage of acetaldehyde precursors according to the present invention is that they have a less pronounced aroma compared to acetaldehyde, diethyl acetal or 1,2-di[(1′-ethoxy)ethoxy]propane.

The present invention provides the use of an acetaldehyde precursor as hereinabove described as a flavoring or fragrance agent.

The invention further provides the use of an acetaldehyde precursor as hereinabove defined as a component of a flavoring or fragrance formulation.

The invention further provides a flavor or a fragrance formulation comprising an acetaldehyde precursor of formula II with n=1, n=2 or n=3.

The invention further provides a consumable product comprising an acetaldehyde precursor of formula II with n=1, n=2 or n=3.

Acetaldehyde precursors according to the present invention may be formulated in various forms well known to a person skilled in the art, including solid, spray dried or encapsulated e.g. granulated, extruded, coacervated, liquid or as an emulsion.

Acetaldehyde precursors according to the present invention may be employed in flavor or fragrance formulations, or directly in consumable products, such as food or fragrance products. Examples include cereal products, rice products, tapioca products, sago products, baker's products, biscuit products, pastry products, bread products, confectionery products, desert products, gums, chewing gums, chocolates, ices, honey products, treacle products, yeast products, baking-powder, salt and spice products, savory products, mustard products, vinegar products, sauces (condiments), tobacco products, cigars, cigarettes, processed foods, cooked fruits and vegetable products, meat and meat products, jellies, jams, fruit sauces, egg products, milk and dairy products, cheese products, butter and butter substitute products, milk substitute products, soy products, edible oils and fat products, medicaments, beverages, alcoholic drinks, beers, soft drinks, mineral and aerated waters and other non-alcoholic drinks, fruit drinks, fruit juices, coffee, artificial coffee, tea, cocoa, or in food products such as including forms requiring reconstitution, food extracts, plant extracts, meat extracts, condiments, sweeteners, nutraceuticals, gelatins, pharmaceutical and non-pharmaceutical gums, tablets, lozenges, drops, emulsions, elixirs, syrups and other preparations for making beverages, instant beverages and effervescent tablets, and combinations thereof.

Especially preferred applications include beverages such as soft drinks, mineral and aerated waters and other non-alcoholic drinks, fruit drinks, fruit juices, and preparations for making beverages including tablets, syrups, instant beverages, effervescent tablets.

The amount of the acetaldehyde precursor added to the foodstuff or fragrance is sufficient to impart the desired fresh flavor, aroma or fragrance. The person skilled in the art will appreciate that the precise amount will vary in wide ranges according to the foodstuff/fragrance or flavor/fragrance composition to be flavored/fragranced and the flavor/fragrance impact sought.

Generally, 0.1 to 500 mg/kg, preferably 0.1-250 mg/kg, more preferably 0.1-100 mg/kg in a food or a beverage may be an organoleptically useful range. The person skilled in the art acknowledges that depending on the application the actual concentration will be within or without of this range in products or formulations.

Acetaldehyde precursors according to the present invention may be present in flavor or fragrance formulations in a concentration of 0.01-1000 g/kg, preferably 0.01-500 g/kg more preferably 0.1-200 g/kg.

A person skilled in the art will appreciate that formulations and products may contain additional ingredients which may comprise various additives and excipients well known in the art, including anti-caking agents, anti-foaming agents, anti-oxidants, binders, colorants, diluents, disintegrants, emulsifiers, encapsulating agents, enzymes, fats, flavor-enhancers, flavoring agents, gums, lubricants, polysaccharides, preservatives, proteins, solubilisers, solvents, stabilisers, sugar-derivatives, surfactants, sweetening agents, vitamins, waxes, and the like. Solvents which may be used are known to those skilled in the art and include e.g. ethanol, ethylene glycol, propylene glycol, glycerin, triacetin, diethyl phthalate and dimethyl phthalate. Encapsulants and gums include maltodextrin, gum arabic, alginates, gelatin, modified starch, and polysaccharides. Examples of additives, excipients, carriers, diluents or solvents for flavor or fragrance compounds may be found e.g. in “Perfume and Flavor Materials of Natural Origin”, S. Arctander, Ed., Elizabeth, N.J., 1960; in “Perfume and Flavor Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1^{st} ed., The Cosmetic, Toiletry and Fragrance Association, Inc., Washington, 1988.

Acetaldehyde precursors according to the present invention are suitable for applications in products with acidic pH e.g. soft drinks or instant beverages and effervescent tablets. The pH in the product ready made drink may be from 2 to 4.5, preferably 2.5 to 4, more preferably from about 2.6 to 3.0.

However, the respective amount of acetaldehyde precursor employed will depend on the respective application, e.g. the pH and desired release rate and desired flavor or fragrance intensity. It will be apparent to the person skilled in the art that for specific applications an amount within or outside of this range may be employed.

The synthesis of 1-ethoxy-1-(1-ethoxy-ethoxy)-ethane may be carried out by modifying a procedure described by Oon and Kubler (S. M. Oon and D. G. Kubler, “Hydrolysis of Aldal Acetals”, J. Org. Chem., 1982, 47, 1166-1171), as is further set out in the Examples. Furthermore, applicant has found that molecules according to formula II with n larger than 1, e.g. 2, 3, 4 or larger can be produced analogously to the aforementioned synthesis by employing acetaldehyde increasingly larger excess.

Alternatively, compounds according to formula II may be prepared from acetaldehyde and ethanol using a molecular sieve, for example, a 6A acidic molecular sieve (CBV8014) may be used.

A mixture of compounds according to formula II with n=1 and n=2 and R₁ may be synthesized by reacting acetaldehyde and ethanol in hexane a catalyst, for example tartaric acid, and if desired, compounds with particular n values may be isolated from the mixture using separation techniques known in the art.

Samples prepared to above-mentioned processes may significantly increase the yield of acetaldehyde during spray drying and minimize losses during storage. 1-ethoxy-1-(1-ethoxy-ethoxy)-ethane itself can be used as nature identical acetaldehyde precursor in dry flavour formulations.

The invention is further described with reference to the following non-limiting examples, which describe preferred embodiments.

### EXAMPLE 1

### Synthesis of 1-ethoxy -1-1-ethoxy-ethoxv-ethane compound of Formula II where n=1

In a 500 mL round bottom flask anhydrous hydrogen chloride gas ( 91 g, 2.5 mol, Aldrich) was bubbled into acetaldehyde (100 g, 2.25 mol, Aldrich) which was cooled to −10° C. to −20° C. After the addition of hydrogen chloride gas was complete, the mixture was cooled to −40° C. to crystallize out the newly-formed water. The solution was filtered, dried over CaCl₂, filtered again, and distilled to give the intermediate, dichlorodiethyl ether (68.68 g, 0.48 mol, 42.7% yield). This material was not further characterized and was used immediately in the next step.

Under nitrogen gas in a 500 mL round bottom flask dichlorodiethyl ether (68.68 g, 0.48 mol) was added dropwise to a sodium ethoxide solution prepared from ethyl alcohol (360 mL) and sodium (23.6 g, 1 mol) cooled to −10° C. to −20° C. The reaction was stirred and allowed to warm up to room temperature. The solution was filtered to remove salt and distilled (24 mmHg, 65-75° C.) to give 1-ethoxy -1-(1-ethoxy-ethoxy)-ethane (10.5 g, 0.06 mol, 12% yield). ¹H NMR ref: 4.85 q, 3.50 dq, 1.23 d, 1.11 t; ¹³C NMR: 98.86, 60.745, 21.12, 15.70; MS: 45, 73, 89, 103, 117, 147

### EXAMPLE 2

### Acetaldehyde Precursors in Orange Flavour Reduces Flash Point

Orange flavor A with 10% acetaldehyde (w/w) shows a flash point of below 4° C. Orange flavor B, where acetaldehyde was substituted by an acetaldehyde precursor corresponding to 10% acetaldehyde according to formula II with n=1 the flash point is +48° C.

| | Orange flavour A with | | Orange flavour B with | |
|---|---|---|---|---|
| | acetaldehyde | | acetaldehyde precursor | |
| orange oil (Brazil) | 77.5 | g | 77.5 | g |
| single fold | | | | |
| orange oil (Brazil) | 5 | g | 5 | g |
| 5-fold | | | | |
| orange oil (Brazil) | 5 | g | 5 | g |
| 25-fold | | | | |
| ethyl butyrate | 2.5 | g | 2.5 | g |
| (CAS 105-54-4) | | | | |
| acetaldehyde | 10 | g | — | |
| (CAS 75-07-0) | | | | |
| compound acc. to | | | 18.4 | g |
| formula II with | | | | |
| n = 1 | | | | |

### EXAMPLE 3

### Acetaldehyde Precursors in Spray Dried Aroma for Instant Beverage

The orange aromas A and B from Example B were spray dried after addition of maltodextrin, and water. The resulting powders were mixed with an instant beverage base and stored at room temperature for 14 days. The instant beverages were dissolved in water (160 g/L). The instant beverage B was more juicy, fresh and reminiscent on fresh squeezed orange juice compared to instant beverage A.

Spray Dried Formula

| | Spray-dried Aroma A | Spray-dried Aroma B |
|---|---|---|
| Orange flavor A | 110 | — |
| Orange flavor B | — | 110 |
| Water | 445 | 445 |
| Maltodextrine | 400 | 400 |
| (CAS 9050-36-6) | | |
| Starch octenyl succinate | 45 | 45 |
| (CAS 9087-61-0) | | |

Instant Beverage Formula

| | Instant | Instant |
|---|---|---|
| | beverage A | beverage B |
| Spray-dried aroma A | 1.2 | — |
| Spray-dried aroma B | — | 1.2 |
| Citric acid (CAS 77-92-9) | 61.5 | 61.5 |
| Saccharose (CAS 57-50-1) | 926.5 | 926.5 |
| Titanoxide (CAS 13463-67-7) | 3.8 | 3.8 |
| Pectin (CAS 9000-69-5) | 3.8 | 3.8 |
| Trisodium citrate (CAS 77-92-9) | 3.2 | 3.2 |

1. An acetaldehyde precursor comprising formula I 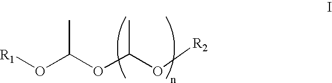
wherein R₁ and R₂ are selected such that both are —CH₂CH₃, or both are linear, branched or cyclic alkyl, aryl, alcohol or sugar residues, and n=1-10, with the proviso that, when R₁ and R₂ are selected such that both are —CH₂CH₃, n=1, 2, 3 or 4.

2. An acetaldehyde precursor according to claim 1 wherein n is 1, 2 or 3 and R₁ and R₂ are both —CH₂CH₃.

3. An acetaldehyde precursor according to claim 1 wherein n is 5, 6, 7, 8, 9, or 10 and the linear, branched or cyclic alkyl, aryl, alcohol or sugar residues are water-soluble.

4. A method comprising utilizing an acetaldehyde precursor according to claim 1 as a flavoring or fragrance agent.

5. A method of preparing a flavoring or fragrance formulation comprising utilizing an acetaldehyde precursor according to claim 1 as a component of the flavoring or fragrance formulation.

6. A flavor or a fragrance formulation comprising an acetaldehyde precursor according to claim 1.

7. A consumable product comprising an acetaldehyde precursor according to claim 1.

8. The flavor or fragrance composition according to claim 6 wherein the acetaldehyde precursor is one in which n=1, n=2 or n=3, and R₁ and R₂ both —CH₂CH₃.

9. The consumable product according to claim 7 wherein the acetaldehyde precursor is one in which n=1, n=2 or n=3, and R₁ and R₂ both —CH₂CH₃.

10. A method comprising utilizing an acetaldehyde precursor according to claim 2 as a flavoring or fragrance agent.

11. A method of preparing a flavoring or fragrance formulation comprising utilizing an acetaldehyde precursor according to claim 2 as a component of the flavoring or fragrance formulation.

12. A flavor or a fragrance formulation comprising an acetaldehyde precursor according to claim 2.

13. The flavor or fragrance composition according to claim 12 wherein the acetaldehyde precursor is one in which n=1, n=2 or n=3, and R₁ and R₂ both —CH₂CH₃.

14. A consumable product comprising an acetaldehyde precursor according to claim 2.

15. The consumable product according to claim 14 wherein the acetaldehyde precursor is one in which n=1, n=2 or n=3, and R₁ and R₂ both —CH₂CH₃.

16. A method comprising utilizing an acetaldehyde precursor according to claim 3 as a flavoring or fragrance agent.

17. A method of preparing a flavoring or fragrance formulation comprising utilizing an acetaldehyde precursor according to claim 3 as a component of the flavoring or fragrance formulation.

18. A flavor or a fragrance formulation comprising an acetaldehyde precursor according to claim 3.

19. The flavor or fragrance composition according to claim 18 wherein the acetaldehyde precursor is one in which n=1, n=2 or n=3, and R₁ and R₂ both —CH₂CH₃.

20. A consumable product comprising an acetaldehyde precursor according to claim 3.

21. The consumable product according to claim 20 wherein the acetaldehyde precursor is one in which n=1, n=2 or n=3, and R₁ and R₂ both —CH₂CH₃.
